(19) United States
(12) Patent Application Publication
(10) Pub. No.: US 2024/0413908 A1
(43) Pub. Date: Dec. 12, 2024

(54) RELAY SYSTEM

(71) Applicant: Nippon Telegraph and Telephone Corporation, Tokyo (JP)

(72) Inventors: Tsuyoshi Ito, Tokyo (JP); Yuki Arikawa, Tokyo (JP); Kenji Tanaka, Tokyo (JP)

(21) Appl. No.: 18/700,606

(22) PCT Filed: Dec. 16, 2021
(86) PCT No.: PCT/JP2021/046625

§ 371 Date: Apr. 11, 2024

(51) Int. Cl. H04B 10/29

(52) U.S. Cl. CPC H04B 10/29

(57) ABSTRACT

A relay system relays data transmitted to any one of a plurality of transmission destinations, and includes a reception unit that receives the data, a conversion unit that converts the data received by the reception unit into an optical signal having a wavelength varying according to a transmission destination to which the data is to be transmitted among the plurality of transmission destinations, and an output unit that outputs the optical signal converted by the conversion unit to an optical transmission line.

### CROSS-REFERENCE TO RELATED APPLICATIONS

This application is a national phase entry of PCT Application No. PCT/JP2021/046625, filed on Dec. 16, 2021, which application is hereby incorporated herein by reference.

### TECHNICAL FIELD

The present invention relates to a relay system.

### BACKGROUND

An optical communication network (for example, a passive optical network (PON)) for transmitting and receiving data in the form of optical signals has been developed in recent years as disclosed in Patent Literature 1. Different pieces of data are transmitted on such an optical communication network in time division multiplexing.

### CITATION LIST

### Patent Literature

PTL 1—Japanese Patent Application Publication No. 2015-198270

### SUMMARY

### Technical Problem

Here, when a plurality of pieces of data having different transmission destinations are transmitted through an optical transmission line in time division multiplexing, the transmission time of all pieces of data (time from the transmission start to the transmission end) is a time obtained by adding up the transmission times of the pieces of data, and the transmission time becomes long.

An object of the present invention is to shorten the transmission time of all of a plurality of pieces of data having different transmission destinations.

### Solution to Problem

In order to solve the above-described problem, a relay system according to the present invention is a relay system that relays data to be transmitted to any of a plurality of transmission destinations and includes a reception unit that receives the data, a conversion unit that converts the data received by the reception unit into an optical signal having a wavelength varying according to a transmission destination to which the data is transmitted among the plurality of transmission destinations, and an output unit that outputs the optical signal converted by the conversion unit into an optical transmission line.

### Advantageous Effects of Invention

According to the present invention, the transmission time of all of a plurality of pieces of data having different transmission destinations can be shortened.

### BRIEF DESCRIPTION OF THE DRAWINGS

FIG. 1 is a configuration diagram of a relay system according to a first embodiment.

FIG. 2 illustrates diagrams showing the wavelengths of optical signals transmitted on each optical transmission line of FIG. 1.

FIG. 3 is a diagram illustrating a configuration example of a table included in the relay system of FIG. 1.

FIG. 4 is a configuration diagram of a relay system according to a second embodiment.

FIG. 5 is a diagram illustrating a configuration example of a table included in the relay system of FIG. 4.

FIG. 6 is a configuration diagram of a relay system according to a third embodiment.

FIG. 7 is a diagram illustrating a configuration example of a table at a normal time included in the relay system of FIG. 6.

FIG. 8 is a flowchart showing an operation performed when the content of the table of FIG. 7 is changed.

FIG. 9 is a diagram illustrating a configuration example of a table with changed content.

### DETAILED DESCRIPTION OF ILLUSTRATIVE EMBODIMENTS

An embodiment of the present invention will be described hereinafter with reference to the drawings. In the following description, elements having the same function, elements having different functions but corresponding to each other, and the like will be described with the same reference numerals given as appropriate. In addition, reference numerals may be given to some of a plurality of elements having the same function or corresponding to each other in the drawings. A “wavelength” described below is an expression including a wavelength band and a wavelength group which is a set of a plurality of discrete wavelengths in addition to one wavelength. When a wavelength means a wavelength band, “different wavelengths” means that the wavelength bands do not overlap. When a wavelength means a group of wavelengths, “different wavelengths” means that the wavelengths included in groups of wavelengths are all different from each other.

### First Embodiment

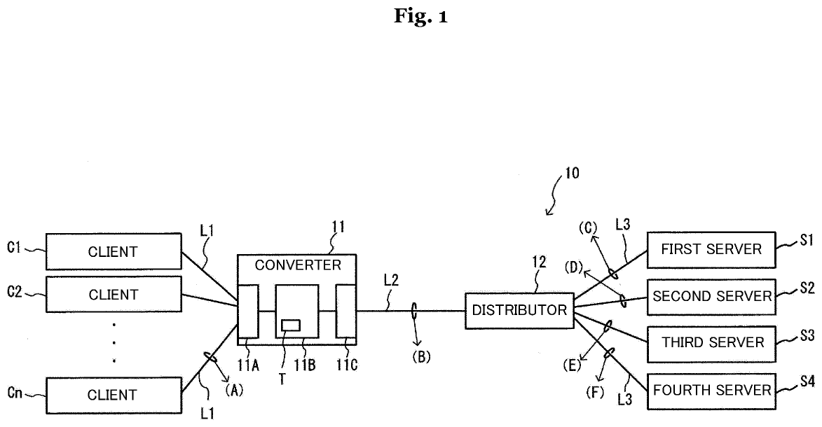

A relay system 10 according to a first embodiment of the present invention includes a converter 11 and a distributor 12 as illustrated in FIG. 1. The relay system 10 is configured to relay data to be transmitted from a plurality of clients C1 to Cn to any of a first server S1 to a fourth server S4 as a plurality of transmission destinations.

The clients C1 to Cn are composed of various client computers or the like. Each of the first server S1 to the fourth server S4 is assumed to be a server computer for providing processing (service) on data from each of the clients C1 to Cn. In the following description, the clients C1 to Cn will be collectively referred to as a “client C”, and the first server S1 to the fourth server S4 will be collectively referred to as a “server S”.

The converter 11 is composed of various computers or the like, and is configured to convert data from the client C into an optical signal having a wavelength corresponding to the server S that is the transmission destination of the data. The converter 11 includes a reception unit 11A, a conversion unit 11B, and an output unit 11C. The reception unit 11A is composed of a communication module or the like. The conversion unit 11B includes, for example, a control circuit and a conversion module for converting data into an optical signal having a desired wavelength under control by the control circuit. The control circuit is composed of at least one, two, or more combinations of a processor such as a central processing unit (CPU) executing a program, and various integrated circuits such as an application-specific integrated circuit (ASIC), a field-programmable gate array (FPGA), and the like. The conversion unit 11B includes a storage unit storing a table T to be described later, the program, and the like. The output unit 11C is composed of an optical terminal or the like for externally outputting an optical signal.

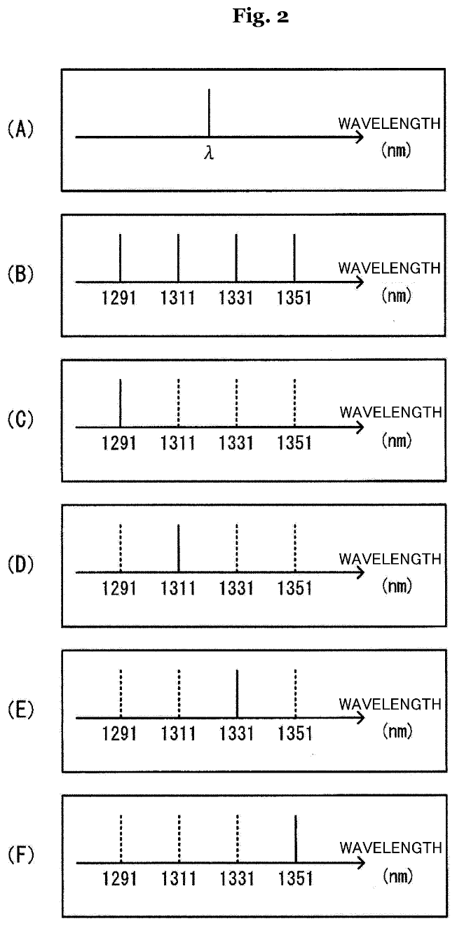

The reception unit 11A is connected to the client C through an optical transmission line L1 composed of an optical fiber or the like. The client C outputs processing target processing target data by any of the servers S and transmission destination information given to the data and designating the server S of the transmission destination of the data in the form of an optical signal. The reception unit 11A receives the processing target data and the transmission destination information output by the client C in the form of an optical signal through the optical transmission line L1. The wavelength of the optical signal in this case may be an arbitrary wavelength λ as shown in (A) of FIG. 2. The reception unit 11A converts the processing target data and the transmission destination information into an electric signal and inputs the electric signal to the conversion unit 11B. The optical signal may be transmitted wirelessly. In this case, the optical transmission line L1 is a space. The client C may transmit the processing target data and the transmission destination information to the reception unit 11A via a prescribed signal transmission line in the form of an electric signal. In this case, the reception unit 11A is composed of a connector or the like that transmits the received electric signal to the conversion unit 11B as it is without converting the signal.

The conversion unit 11B converts the processing target data from the reception unit 11A into an optical signal having a different wavelength according to the transmission destination (server S) designated by the transmission destination information. The conversion unit 11B refers to the table T stored in the storage unit to specify the wavelength of the optical signal to be converted. Further, a position of the table T is not limited as long as the conversion unit 11B can refer to the table T. The table T may be stored in an external storage unit of the converter 11.

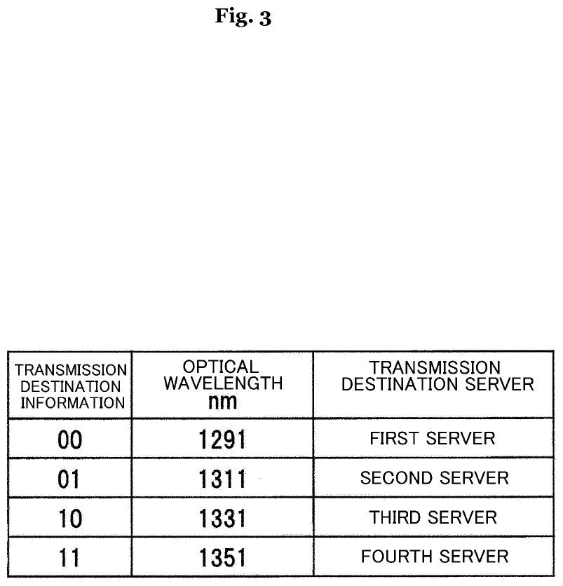

In the table T, for example, wavelengths “1291 nm”, “1311 nm”, “1331 nm”, and “1351 nm” are allocated to pieces of transmission destination information “00” to “11” (binary numbers) designating the first server S1 to the fourth server S4, respectively, as illustrated in FIG. 3. Further, wavelengths are not limited to the above-mentioned wavelengths as long as they are different from each other.

The conversion unit 11B refers to the table T by using transmission destination information received from the reception unit 11A as a key to acquire a wavelength corresponding to the transmission destination information. The conversion unit 11B converts the data from the reception unit 11A into an optical signal having the acquired wavelength. Thus, for example, when the transmission destination information is “00”, an optical signal having “1291 nm” is generated.

The output unit 11C outputs the converted optical signal converted by the conversion unit 11B to an optical transmission line L2 composed of an optical fiber or the like.

The reception unit 11A may input the received data to the conversion unit 11B as an optical signal without changing the received data to electronic data. The conversion unit 11B may convert an input optical signal into an optical signal having a wavelength corresponding to the transmission destination information by using a wavelength conversion element or the like.

The optical transmission line L2 transmits the optical signal output by the output unit 11C to the distributor 12. The optical transmission line L2 is configured to transmit a plurality of kinds of optical signals having superimposed different wavelengths. The wavelengths adopted by the optical signal transmittable through the optical transmission line L2 include “1291 nm”, “1311 nm”, “1331 nm”, and “1351 nm” corresponding to each of the first server S1 to the fourth server S4 as illustrated in (B) of FIG. 2.

The distributor 12 is connected to the optical transmission line L2 and the first server S1 to the fourth server S4. The distributor 12 is connected to the first server S1 to the fourth server S4 via four optical transmission lines L3, respectively. The distributor 12 distributes the optical signal input from the optical transmission line L2 to a transmission destination corresponding to the wavelength of the optical signal among the first server S1 to the fourth server S4 being transmission destinations. For example, when the wavelength of the optical signal is “1291 nm”, the optical signal is distributed to the first server S1.

The distributor 12 is composed of a passive wavelength separator or the like. The distributor 12 includes, for example, a demultiplexer that demultiplexes an optical signal from the optical transmission line L2 into optical signal having wavelengths “1291 nm”, “1311 nm”, “1331 nm” and “1351 nm” of the optical signal that can be output from the converter 11, and four output terminals for outputting the respective demultiplexed optical signals, respectively. The four output terminals are connected to the first server S1 to the fourth server S4, respectively, via four optical transmission lines L3 composed of optical fibers or the like. With this configuration, the optical signal from the optical transmission line L2 is distributed and transmitted to the server S of the transmission destination corresponding to the wavelength of the optical signal. The optical signal is transmitted to the server S via the transmission line L3. Due to the distribution, the wavelength of the optical signal transmitted on the transmission line L3 connected to the first server S1 is “1291 nm” as shown in (C) of FIG. 2. Similarly, the wavelengths of optical signals transmitted on the three transmission lines L4 respectively connected to the second server S2 to the fourth server S4 are “1311 nm”, “1331 nm”, and “1351 nm”, respectively, as illustrated in (D) to (F) of FIG. 2.

Each of the first server S1 to the fourth server S4 receives the optical signals distributed by the distributor 12, converts the optical signals into electronic data or the like, and processes the data. The data of the processing result is returned to the client C of the transmission source of the original processing target data, for example.

Any method may be adopted to return data of a processing result to the client. For example, identification information of the client C is attached to data from the client C. The server S returns the identification information and the data of the processing result to the distributor 12 in the form of an optical signal through the optical transmission line L3 or another transmission line. The distributor 12 has a function similar to that of the converter 11 to convert data of a processing result from the server S into an optical signal having a wavelength (preferably different from a wavelength corresponding to transmission destination information) corresponding to the identification information, and transmits the optical signal to the converter 11 via the optical transmission line L2 or another transmission line. The converter 11 has a function similar to that of the distributor 12 to transmit the received optical signal to the client C corresponding to the wavelength via the optical transmission line L1 or another transmission line.

The C-plane signal or the like exchanged between the client C and the server S may be an optical signal of an arbitrary wavelength.

In this embodiment, the processing target data is converted into an optical signal having a wavelength corresponding to a transmission destination of the data, that is, any one of the first server S1 to the fourth server S4, and output to the optical transmission line L2. Thus, even if the output timings of the processing target data having different transmission destinations are partially or entirely overlapped in time series, the conversion unit 11B can convert the processing target data into optical signals having different wavelengths, and transmit each of the converted optical signals to the optical transmission line L2 through the output unit 11C by using wavelength multiplexing. Thus, the transmission time of all of the plurality of pieces of data having different transmission destinations is shortened by the time that time division multiplexing is not used. In addition, when pieces of data having different transmission destinations are transmitted, congestion due to time division multiplexing does not occur, and latency in transmission of data is also reduced. Furthermore, in PON or the like, bands are controlled through negotiation between devices competing data transmission and reception in order to avoid congestion, however data transmission is delayed by the time for the round-trip transmission of the data for negotiation. In the present embodiment, such negotiation is not required, and thus such latency is avoided.

The optical signals are suitably transmitted to the transmission destinations by the distributor 12 for distributing the optical signals received from the optical transmission line L2 to the servers S corresponding to the wavelengths of the optical signals. Further, the servers S may be directly connected to the optical transmission line L2 via an optical coupler or the like without providing the distributor 12. In this case, the server S needs to have an optical filter or the like for transmitting only an optical signal having the wavelength corresponding to the server itself among light from the optical transmission line L2. On the other hand, if the distributor 12 is provided, the server S does not need to have the optical filter or the like, and can be used as a general-purpose server capable of receiving an optical signal. When the distributor 12 is not provided, the relay system 10 may be composed only of the converter 11.

Furthermore, since the conversion into the optical signals is performed by referring to the table T in which the transmission destination information and the wavelengths are associated, the conversion into the optical signals is performed through simple processing. Furthermore, since the contents of the table T can be easily changed (refer to the third embodiment described later), the correspondence between the transmission destinations and the wavelengths can be easily changed.

### Second Embodiment

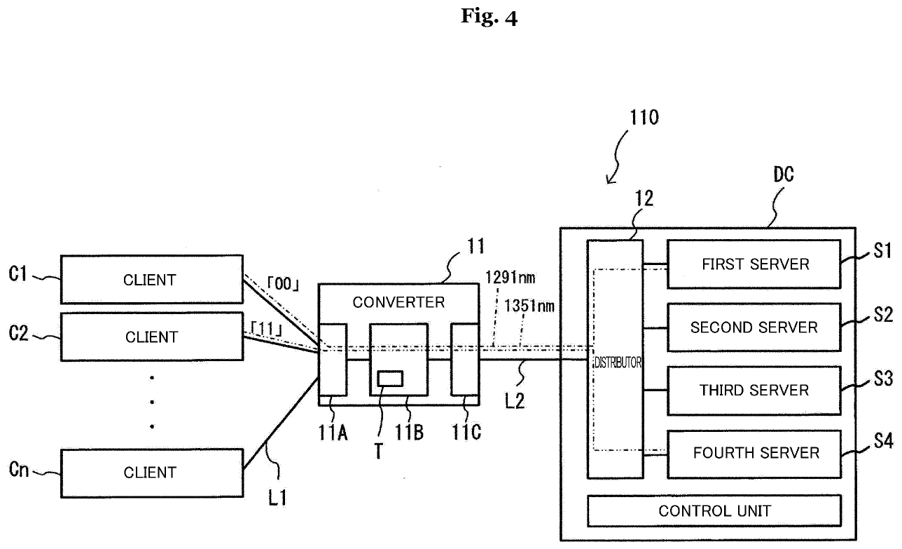

In the embodiment, the first server S1 to the fourth server S4 are constructed with computer resources provided in a disaggregated computer DC (hereinafter also referred to simply as a computer DC) as illustrated in FIG. 4. Examples of the computer resources include CPUs, graphics processing units (GPU), FPGAS, ASICs, and the like. As in the present embodiment, the first server S1 to the fourth server S4 as transmission destinations of data may be a functional unit provided in one device.

In a relay system 110 according to the present embodiment, a distributor 12 is disposed in the computer DC. In such a case, the relay system 10 may be regarded as being composed only of a converter 11. Although the distributor 12 may adopt an arbitrary configuration, it may be composed of an optical path or the like.

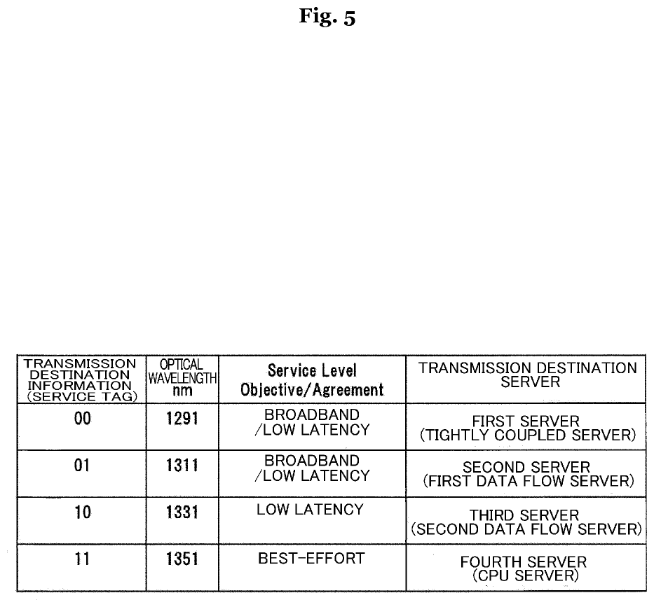

The first server S1 to the fourth server S4 have service levels as shown in the table T of FIG. 5. The first server S1 is configured as a tightly coupled server having a broadband and low-latency service level. The second server S2 is configured as a first data flow server having a broadband and low-latency service level. The third server S3 is configured as a second data flow server having a low-latency service level. The first data flow server and the second data flow server are configured as different servers depending on different resources. The fourth server S4 is configured as a CPU server with best-effort. In this embodiment, the first server S1 to the fourth server S4 which are the transmission destinations of data from clients C provide different service levels, and the transmission destinations of data also indicate the service target level required for processing the data. Therefore, information of the transmission destinations of the present embodiment can also be said as a service tag for designating a service or a service target level. The services provided by the first server S1 to the fourth server S4 may be the same or different types of services. The service level may include a non-operation rate or the like.

When “00” is given to processing target data from the client C1 as transmission destination information, the processing target data is converted into an optical signal having a wavelength of 1291 nm by the converter 11 and supplied to the distributor 12. The distributor 12 distributes the supplied optical signal as it is to the first server S1 which is a tightly coupled server. The first server S1 is designed to be tuned in broadband and low-latency to provide the service of the service target level designated by the transmission destination information (service tag).

When “11” is given to processing target data from the client C2 as transmission destination information, the processing target data is converted into an optical signal having a wavelength of 1351 nm by the converter 11 and supplied to the distributor 12. The distributor 12 distributes the supplied optical signal as it is to the fourth server S4 which is a CPU server. The fourth server S4 calculates data represented by the supplied optical signal by using a general-purpose CPU. At this time, the service level of the fourth server S4 is set to best-effort, and the fourth server S4 processes distributed optical signals with best-effort.

The description of other configurations of the present embodiment is similar to that of the first embodiment.

According to the present embodiment, a dedicated wavelength can be allocated to the client C requiring low latency, thereby ensuring the service target level requested by the user. For example, one client C (the client C1 in the above case) of a user who requests a low-latency service can be allocated to the first server S1 operating with low latency. In this case, transmission destination information of the first server S1, that is, a wavelength corresponding to the first server S1, is allocated only to the client C, thus a transmission source of the processing target data transmitted to the first server S1 is limited, and low latency is secured. Further, a plurality of clients C having different output timings of the processing target data may be allocated to the first server S1. This description is similarly applied to the second server S2 having the same low latency.

Furthermore, a plurality of clients C may be allocated to the third server S3 and the fourth server S4 operating in best-effort, and a plurality of pieces of processing target data may be simultaneously input to the converter 11 from the plurality of clients C, respectively. In other words, a plurality of pieces of processing target data to which the same transmission destination information is given and which are at least partially overlapped in time series may be supplied to the converter 11. In this case, the conversion unit 11B converts the plurality of pieces of processing target data received by the reception unit 11A into each of a plurality of optical signals having the same wavelength, and transmits the plurality of converted optical signals to the optical transmission logic L2 in time division multiplexing through the output unit 11C. In such a case, latency in data transmission by time division multiplexing may occur for the third server S3 and the fourth server S4. However, a dedicated wavelength is allocated to the client C using the first server S1 or the second server S2 which requires low latency, and thereby the influence of the latency thereon is minimized. Therefore, the transmission time of a plurality of pieces of data having different transmission destinations is shorter than that when all of the plurality of pieces of data are transmitted in time division multiplexing.

In this way, the conversion unit 11B may convert a plurality of pieces of data received as processing target data by the reception unit 11A and having different transmission sources but having the same transmission destination (for example, the third server S3 or the fourth server S4) into a first optical signal having the same wavelength, and transmit the converted first optical signal to the optical transmission line L2 through the output unit 11C in time division multiplexing. The conversion unit 11B may convert data received as processing target data by the reception unit 11A having a transmission destination (for example, the first server S1) different from the transmission destination of the plurality of pieces of data into a second optical signal having a wavelength different from that of the first optical signal, and transmit the converted second optical signal to the optical transmission line L2 through the output unit 11C by superimposing the wavelength on that of the first optical signal (wavelength multiplexing). Thus, the transmission time of the plurality of pieces of data having different transmission destinations is shortened as described above. In addition, since simultaneous transmission of the plurality of pieces of data in time division multiplexing is enabled by using the first optical signal, the number of pieces of data which can be simultaneously transmitted is increased by allowing a certain level of latency, and latency in transmission is minimized without performing time division multiplexing on the second optical signal.

The computer DC can dynamically change a server S (service) built in the computer itself in order to reduce power consumption or the like. This change includes a change in hardware constituting the server S and a change in the mode of the server S (for example, a change from a tightly coupled server to a data flow server). The change is made within a predetermined range not to lower the service level of the server S.

### Third Embodiment

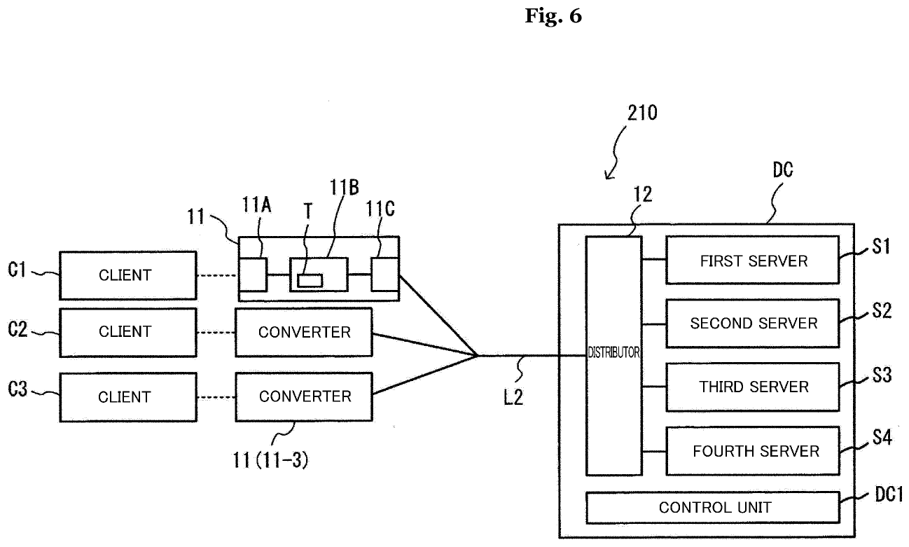

A relay system 210 according to a third embodiment includes three converters 11 as illustrated in FIG. 6. In addition, the clients C1 to Cn are set as clients C1 to C3. The converters 11 are connected to the clients C in a one-to-one manner. The converters 11 and the clients Care connected wirelessly (for example, using millimeter waves). In this configuration, there is an advantage that no congestion occurs in communication between the clients C and the converters 11. The converters 11 may be disposed in the clients C. The number of converters 11 and clients C is arbitrary. The converters 11 and the clients C may be connected by wire.

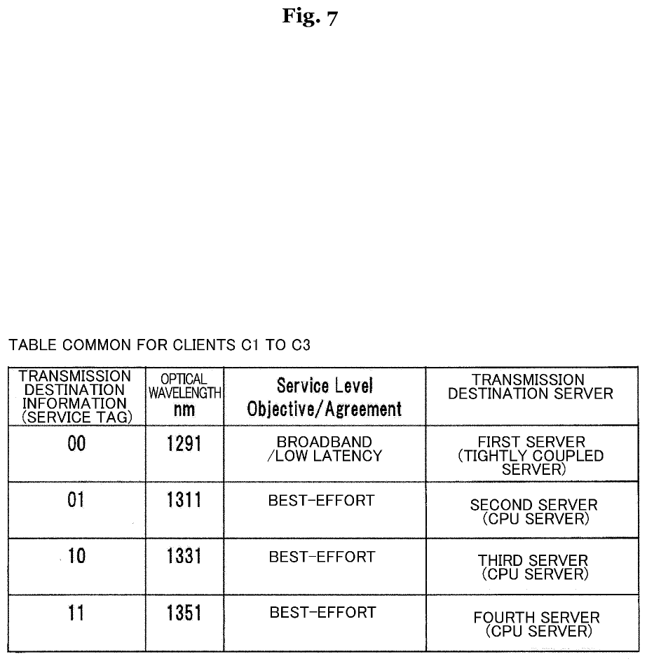

A table T according to the present embodiment has content common for the three converters 11. In the table T, as shown in FIG. 7, CPU servers of best-effort are set as a second server S2 to a fourth server S4 to transmission destination information “01” to “11”. Normally, it is assumed that the client C1 outputs “01” as transmission destination information, the client C1 outputs “10” as transmission destination information, the client C3 outputs “11” as transmission destination information. Thus, the clients C1 to C3 enjoy the best-effort service from the second server S2 to the fourth server S4, respectively. This state is referred to as a normal operation state. The second server S2 to the fourth server S4 have the same arithmetic resources and may sequentially process data from the clients C1 to C3. The second server S2 to the fourth server S4 may have different arithmetic resources. In addition, each of the clients C1 to C3 may output “11” as transmission destination information. In this case, the conversion unit 11B of each converter 11 may convert the processing target data from the clients C1 to C3 into optical signals having the same wavelength and transmit the converted optical signals to the optical transmission L2 through the output unit 11C in time division multiplexing.

The clients C1 to C3 are assumed to be automobiles traveling on a highway, and the processing target data are assumed to be measurement data indicating measurement results measured by various sensors (including cameras) mounted on the automobiles. Many converters 11 are disposed on the highway. Further, a plurality of converters 11 may be provided at each of fixed points on the highway to communicate with a plurality of clients C in a one-to-one manner. Three converters 11 among the many converters 11 at positions close to the clients C1 to C3 are connected to the clients C1 to C3, respectively. A computer DC processes the measurement data transmitted from the clients C1 to C3 by using the servers S, generates autonomous driving data for controlling the driving of the clients C1 to C3, and returns the autonomous driving data to the clients C1 to C3. As described above, autonomous driving of the automobiles is assumed in this embodiment. It is assumed that control of autonomous driving is usually provided at the service level of service effort.

In the present embodiment, the content of the table T can be dynamically changed, and even if the service requested changes over time, the change can be flexibly handled. This point will be described below with reference to FIGS. 6 to 9.

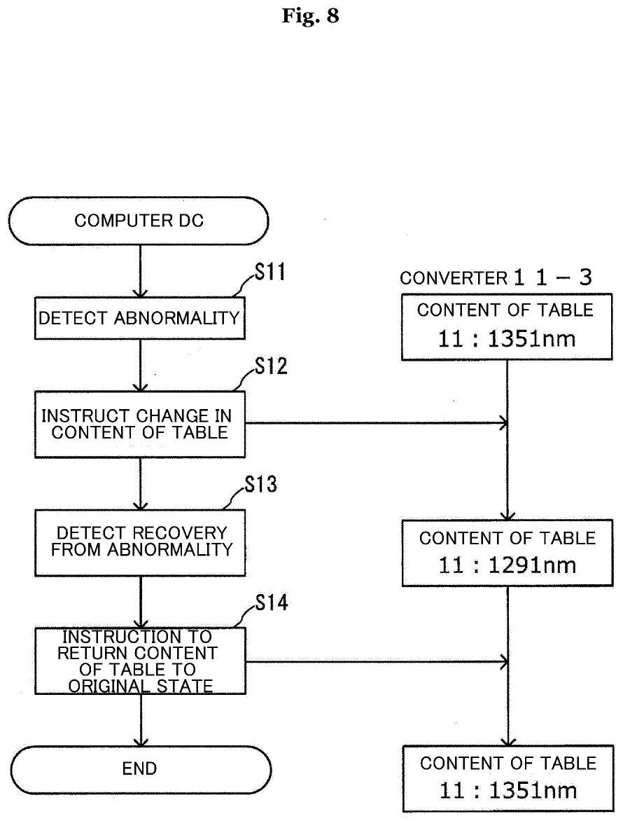

It is assumed that a computer DC (for example, a control unit DC1) has detected an abnormality requiring emergency control over autonomous driving such as avoidance of a collision accident occurs (which may be a high possibility of abnormality) to the client C3 among the three clients C1 to C3 in FIG. 6 (step S11 in FIG. 8). Any method may be used for the detection. For example, when a client C1 as an automobile detects (including prediction) an abnormality in the behavior of a client C3 traveling ahead of the client C1 (for example, traveling toward the central separation zone by protruding the lane) by artificial intelligence or the like using a camera of the client C1, the client C1 transmits information indicating the abnormality to the computer DC as a kind of the measurement data. The control unit DC1 of the computer DC detects the abnormality by receiving the information thereof.

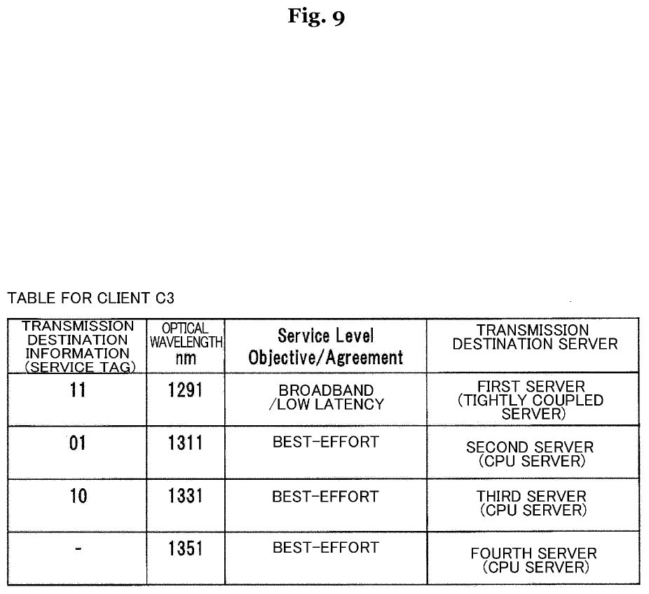

When the abnormality is detected, the computer DC (for example, the control unit DC1) instructs a change in the content of the table T (FIG. 7) of the converter 11 (also referred to as a “converter 11-3” below) to the converter 11-3 being connected to the client C3 using a C-plane signal (step S12). This instruction is an instruction to change the wavelength 1351 nm corresponding to the transmission destination information “11” to 1291 nm of a service wavelength with low latency. The conversion unit 11B of the converter 11-3 changes the transmission destination information “00” corresponding to the wavelength “1291 nm” of the table T (FIG. 7) to “11” based on the instruction, and makes the transmission destination information “11” corresponding to the wavelength “1351 nm” blank (refer to the table in FIG. 8). The table T after this change is shown in FIG. 9. Thereafter, data from the client C3 is converted into an optical signal having 1291 nm, and processed with low latency by the first server S1 in the computer DC. Thus, emergency control over autonomous driving for the client C3 is executed with low latency, and the avoidance of an accident is attempted.

When detecting recovery from the abnormality of the client C3 (step S13), the computer DC (for example, the control unit DC1) supplies a C-plane signal indicating an instruction to return the current table T (FIG. 9) to the table T (FIG. 7) before the abnormality to the converter 11-3 (step S14). The abnormality recovery may be determined based on various kinds of information from the client C1 or C3. The conversion unit 11B of the converter 11-3 changes the content of its own table T in response to the instruction. Thereafter, the client C3 receives a best-effort service like the other clients C1 and C2 do.

Description about other configurations is the same as that of the first and second embodiments, and thus will be omitted. Further, the first server S1 to the fourth server S4 may be constituted by separate server computers as illustrated in FIG. 1.

The clients C1 to C3 may be drone or the like. The servers S acquire various kinds of measurement data from the clients C1 to C3 as processing target data, and controls operations of the clients C1 to C3 based on the acquired various kinds of measurement data. The clients C1 to C3 as drones or the like may monitor mutual behaviors, supply information of the client C determined to have an abnormality in the behavior to the computer DC, and perform emergency control over an operation caused by a change in the transmission destination information or the wavelength.

As described above, the conversion unit 11B may change the table T according to an instruction from the outside (which may be a device other than the computer DC) of the converter 11 (especially, the conversion unit 11B). Thus, it is possible to flexibly cope with a service request changing with time, especially a change from a service of a service effort that allows latency to a service with low latency that does not allow latency.

As in this embodiment, the relay system 210 for relaying processing target data transmitted from a plurality of transmission sources (clients C) may include a plurality of converters 11 each including the reception unit 11A, the conversion unit 11B, and the output unit 11C. The plurality of converters 11 may be connected to the plurality of transmission sources wirelessly or by wire. Thus, since a wavelength conversion is performed by each converter 11, the wavelength of the optical signal after conversion can be allocated to each converter 11. Furthermore, in a first case (normal time or the like), the conversion unit 11B of each of two or more converters 11 (clients C1 to C3 in the above description) among the plurality of converters 11 may convert processing target data received by the reception unit 11A into an optical signal having the same first wavelength (for example, 1351 nm corresponding to “11” described above), and in a second case (an emergency or the like) different from the first case, the conversion unit 11B of one converter 11 (the client C3 in the above description) of the two or more converters 11 may change the wavelength of the optical signal to be converted from the first wavelength to a second wavelength. Thus, latency in transmission of a specific optical signal (an optical signal having the second wavelength) in a special case such as an emergency can be minimized. Switching between the first case and the second case may be arbitrarily performed, and may be performed manually, for example.

Although the example in which the table T of the converter 11 is dynamically changed has been introduced in this embodiment, a control signal (C-plane signal) for instructing the client C to change transmission destination information to be transmitted together with processing target data may be supplied from the outside of the computer DC or the like. For example, an instruction to change transmission destination information to be transmitted from “11” to “01” may be supplied to the client C3 without changing the table T. Such a configuration can also be applied to a configuration in which one converter 11 is provided for a plurality of clients C as illustrated in FIG. 1, FIG. 4, or the like.

### SCOPE OF PRESENT INVENTION

The present invention is not limited to the foregoing embodiments and modified examples. For example, the present invention includes various changes to the above embodiments and modified examples that can be understood by those skilled in the art within the scope of the technical idea of the present invention. The structures described in the above-mentioned embodiments and the modified examples can be appropriately combined within a range without contradiction. The relay system may be an object whose elements are housed in one housing, such as when the relay system is composed of only a converter. A transmission destination of data relayed by the relay system may be a client computer or the like instead of a server or the like. The relay system may include at least one of a transmission source transmitting processing target data (data to be relayed) such as a client C and a plurality of servers as transmission destinations of the data.

### REFERENCE SIGNS LIST

10 Relay system
11 Converter
11-3 Converter
11A Reception unit
11B Conversion unit
11C Output unit
12 Distributor
110 Relay system
210 Relay system
L1 to L3 Optical transmission line
S1 First server
S2 Second server
S3 Third server
S4 Fourth server

1-7. (canceled)

8. A relay system, comprising:
a receiver configured to receive first data to be transmitted;
a converter configured to convert the first data received by the receiver into a first optical signal having a first wavelength based on a first transmission destination to which the first data is to be transmitted among a plurality of transmission destinations; and
an output configured to output the first optical signal to the first transmission destination via an optical transmission line.

9. The relay system according to claim 8, further comprising a distributor between the optical transmission line and the plurality of transmission destinations, the distributor configured to distribute the first optical signal to the first transmission destination based on the first wavelength of the first optical signal.

10. The relay system according to claim 8, wherein converter is configured to:
convert a plurality of first pieces of data received as the first data by the receiver, the plurality of first pieces of data having different transmission sources and a same transmission destination, into the first optical signal having the first wavelength, and transmit the first optical signal to the optical transmission line through the output in time division multiplexing.

11. The relay system according to claim 10, wherein the converter is further configured to:
convert second data received by the receiver, the second data having a second transmission destination different from the first transmission destination, into a second optical signal having a second wavelength different from the first wavelength of the first optical signal, and transmit the second optical signal to the optical transmission line through the output by superimposing the second wavelength of the second optical signal on the first wavelength of the first optical signal.

12. The relay system according to claim 8, wherein transmission destination information designating the first transmission destination is included in the first data, and a pre-conversion circuit acquires the first wavelength corresponding to the transmission destination information based on a table, wherein the table correlates each of the plurality of transmission destinations with a respective wavelength.

13. The relay system according to claim 12, wherein
the converter is configured to update the table in response to an instruction from outside of the converter.

14. The relay system according to claim 8, wherein
data relayed by the relay system includes data transmitted from a plurality of transmission sources,
the relay system comprising a plurality of receivers, a plurality of converters, and a plurality of outputs, and
each of the plurality of receivers is connected to a respective one of the plurality of transmission sources.

15. The relay system according to claim 14, wherein in response to a first operation mode, a first converter of the plurality of converters and a second converter of the plurality of converters are configured to convert third data received by a first receiver of the plurality of receivers and fourth data received by a second receiver of the plurality of receivers into a third optical signal and a fourth optical signal, respectively, the third optical signal and the fourth optical signal each having a second wavelength.

16. The relay system according to claim 15, in response to a second operation mode, changing a conversion wavelength of the plurality of converters from the second wavelength to a third wavelength different from the second wavelength, the first converter and the second converter are configured to convert fifth data received by the first receiver and sixth data received by the second receiver into a fifth optical signal and a sixth optical signal, respectively, the fifth optical signal and the sixth optical signal each having the third wavelength.

17. A method, comprising:
receiving, by a receiver, first data to be transmitted;
converting the first data received by the receiver into a first optical signal having a first wavelength based on a first transmission destination to which the first data is to be transmitted among a plurality of transmission destinations; and
outputting the first optical signal to the first transmission destination via an optical transmission line.

18. The method according to claim 17, further comprising:
distributing, by a distributor between the optical transmission line and the plurality of transmission destinations, the first optical signal to the first transmission destination based on the first wavelength of the first optical signal.

19. The method according to claim 17, wherein the first data comprises a plurality of first pieces of data, the plurality of first pieces of data having different transmission sources and a same transmission destination, wherein each of the plurality of first pieces of data is converted into the first optical signal having the first wavelength, and wherein outputting the first optical signal to the first transmission destination comprises transmitting the first optical signal to the optical transmission line in time division multiplexing.

20. The method according to claim 19, wherein the method further comprises:
receiving second data to be transmitted to a second transmission destination different from the first transmission destination;
converting second data into a second optical signal having a second wavelength different from the first wavelength of the first optical signal; and
transmitting the second optical signal to the optical transmission line by superimposing the second wavelength of the second optical signal on the first wavelength of the first optical signal.

21. The method according to claim 17, wherein transmission destination information designating the first transmission destination is included in the first data, and the method further comprising:
determining the first wavelength corresponding to the transmission destination information based on a table, wherein the table correlates each of the plurality of transmission destinations with a respective wavelength.

22. The method according to claim 21, wherein the method further comprises:
receiving an instruction; and
updating the table in response to the instruction.
